(19) United States
(12) Patent Application Publication
(10) Pub. No.: US 2010/0106684 A1
(43) Pub. Date: Apr. 29, 2010

(54) SYNCHRONIZATION OF A CONCEPTUAL MODEL VIA MODEL EXTENSIONS

(75) Inventors: Michael J. Pizzo, Bellevue, WA (US); Siva Muhunthan, Kirkland, WA (US); Lev Novik, Bellevue, WA (US); Pablo M. Castro, Redmond, WA (US)

Correspondence Address: WOLF GREENFIELD (Microsoft Corporation);C/O WOLF, GREENFIELD & SACKS, P.C., 600 ATLANTIC AVENUE, BOSTON, MA, 02210-2206, US

(73) Assignee: Microsoft Corporation, Redmond, WA (US)

(21) Appl. No.: 12/544,125

(22) Filed: Aug. 19, 2009

Related U.S. Application Data
(63) Continuation of application No. 12/540,206, filed on Aug. 12, 2009.
(60) Provisional application No. 61/108,527, filed on Oct. 26, 2008.

(51) Int. Cl. G06F 17/30

(52) U.S. Cl. 707/610; 707/E17.005

(57) ABSTRACT

A method of synchronizing data between multiple endpoints each storing a copy of the data in accordance with different underlying schemas. An application model that provides a logical representation of an underlying schema is extended with a synchronization model that provides a logical representation of changes made to the data. The synchronization model comprises functions that provide synchronization information on the changes in a common format. Using such synchronization information, changes in a copy of the data stored in a first underlying schema on a first endpoints are applied to another copy of the data stored in a second underlying schema on a second endpoint in synchronization relationship with the first endpoint.

### CROSS REFERENCE TO RELATED APPLICATIONS

This continuation application claims the benefit under 35 U.S.C. §120 of U.S. application Ser. No. 12/540,206, entitled “SYNCHRONIZATION OF A CONCEPTUAL MODEL VIA MODEL EXTENSIONS,” filed on Aug. 12, 2009, which claims the benefit under 35 U.S.C. §119(e) of Provisional Application Ser. No. 61/108,527, entitled “ENTITY MODEL SYNCHRONIZATION VIA MODEL EXTENSIONS,” filed Oct. 26, 2008, and this application claims the benefit under 35 U.S.C. §119(e) of Provisional Application Ser. No. 61/108,527, entitled “ENTITY MODEL SYNCHRONIZATION VIA MODEL EXTENSIONS,” filed Oct. 26, 2008, all of the foregoing of which are hereby incorporated by reference in their entirety.

### BACKGROUND

Computational and memory demands on computing systems continue to increase exponentially as technology develops newer and ever more powerful applications. One such area that has seen recent growth relates to requirements to database processing technologies. These technologies deal with dimensional aspects such as row and column processing and are now being coupled with other processing models such as, for example, traditional object models having a class/inheritance structure. Thus, many systems may need to support both relational database models and object based models. The systems may also need methods that bridge gaps between these models. In addition to concrete programming models, other types of models such as conceptual models that are viewed as design artifacts and allow developers to describe components in terms of a desired structure may be used. Demands to support such models are often placed on an operating system where a plurality of applications interact with the operating system and employ it to interact with other applications.

Object-oriented programming (OOP) in a programming language relates to classes or types which encapsulate state and behavior. Historically, a program has been viewed as a logical procedure that takes input data, processes it, and produces output data. The programming challenge was seen as how to write the logic, not how to define the data. Object-oriented programming takes the view that what one really is interested in are the objects to manipulate rather than the logic required to manipulate them. Examples of objects range from human beings (described by name, address, and other characteristics) to buildings and floors (whose properties may be described and managed) down to the display objects on a computer desktop (such as buttons and scroll bars).

One aspect in OOP is to identify the objects to manipulate and how they relate to each other, an exercise often known as object modeling. When an object has been identified, it may be generalized as a class of objects. Then, one may define the type of data it contains and any logic sequences that may manipulate it. Each distinct logic sequence is known as a method. A real instance of a class is called an “object” or, in some environments, an “instance of a class.” The object or class instance is what executes on the computer. The object's methods provide computer instructions and the class object characteristics provide relevant data. In contrast to object models, relational database models are now described.

A relational model provides a model for describing structured data based on an assertion that all data may be described as a series of n-ary relationships. At the core of the relational model is the ability to describe any structure in terms of a series of related tuples which one may reason about with relational algebra. The relational model supports common relational databases that are often supported by some type of query language for accessing and managing large amounts of data. Structured Query Language (SQL) is a prevalent database processing language and may be the most popular computer language used to create, modify, retrieve and manipulate data from relational database management systems. In general, SQL was designed for a specific, limited purpose -querying data contained in a relational database. As such, it is a set-based, declarative computer language rather than an imperative language such as C or BASIC which, being general-purpose, were designed to solve a broader set of problems.

Conceptual models typically provide a grammar with which one may describe a model. Conceptual models are typically, just as described, conceptual—where they have typically been design time artifacts that are realized in terms of database schemas or object models. Conceptual models provide developers with a tool to describe the behavior or nature of a problem in an abstracted manner, where schemas are often employed as a component of such models. For example, a conceptual schema, or high-level data model or conceptual data model, provides a map of concepts and their relationships. A conceptual schema for an art studio, for example, could include abstractions such as students, painting, critiques, and showcases.

Synchronization of data is increasingly becoming a cornerstone for providing highly available, redundant, distributed data access with rich functionality and low latency. However, where the different sources being synchronized were not designed with a common schema, synchronization can be a challenging task.

### SUMMARY

The experience for a user of multiple devices storing copies of the same data accessed and manipulated by the user may be improved by providing timely and efficient synchronization of the data across the devices. This may be particularly helpful when the devices store respective copies of the data in accordance with different underlying schemas, which would typically complicate the data synchronization.

Functions may be provided that extend a conceptual representation of the stored data as seen by applications accessing the data. Such functions allow representing information on changes made to the data stored on a device in one underlying schema in a common format which is understood by similar functions on another device that stores a copy of the data in a different underlying schema. Thus, the functions allow abstracting an underlying schema of the stored data from representation of the changes made to the data. As a result, computing devices in a common synchronization environment may not need to understand each other's data storage schemas and synchronize their respective local copies of the data in terms of the conceptual representation of the changes made to the data, which may improve performance of the data synchronization process.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a high-level exemplary diagram of an environment in which some embodiments of the invention may be implemented;

FIG. 2 is a block diagram illustrating components according to some embodiments of the invention;

FIG. 3 is a block diagram illustrating components of two endpoints across which data is synchronized according to some embodiments of the invention;

FIG. 4 is a block diagram illustrating metadata according to some embodiments of the invention;

FIG. 5 is a flowchart providing a high-level illustration of synchronization of data according to some embodiments of the invention;

FIG. 6 is a flowchart providing exemplary details of synchronization of data according to one embodiment of the invention;

FIG. 7 is a schematic block diagram that illustrates an artificial intelligence component that may interact with a synchronization provider component according to one embodiment of the invention;

FIG. 8 is a block diagram of an exemplary computing environment in which some embodiments of the invention may be implemented; and

FIG. 9 is a high-level block diagram of a computing environment in which some embodiments of the invention may be implemented.

### DETAILED DESCRIPTION

The inventors have recognized and appreciated that conventional approaches to tracking changes in multiple copies of data stored on different devices and synchronizing the devices with respect to the changes may not meet user expectations. The computing devices, or endpoints, may each store respective copies of the data in accordance with different formats (e.g., relational database schemas). Consequently, to apply a change in one copy of the data stored on an endpoint to another copy stored on a different endpoint, agreement between logical schemas in accordance with which the data is stored on the endpoints may be required. Thus, it may be difficult to synchronize the data copies to keep them in coherence with each other.

It is known that applications may access data stored on an underlying storage using an application model. Typically, the application model provides a conceptual representation of the stored data may be mapped to a logical schema according to which the data is stored.

The applicants have recognized and appreciated that by extending the application model to include change information, any number of applications that maintain data in a distributed fashion may be readily programmed to perform synchronization functions. Information on changes to the stored data (e.g., insertions, deletions, updates, changes to a version of the data and others) may be stored separately or otherwise associated with the actual stored data. Such information required for synchronization of the data across multiple sources may be accessed to determine what, when and by whom the changes have been made to the data.

Conventionally, care was taken in designing distributed databases to provide a common schema for data items that needed to be synchronized. For example, in a distributed system for managing contacts or appointments, every copy of the database stores data representing a contact or appointment in the same format. In this way, the change to a contact or appointment in one database can be identified and a similar change can be applied to any copies of the database. Such a need for synchronizing copies of databases could arise, for example, for a user that has a desktop computer and a “smart” phone, both of which store copies of the users appointments and contacts.

In scenarios in which the underlying data in different copies of a database have different formats, synchronizing changes between multiple endpoints storing replicas of the data is a challenge, which may require special programming to relate changes made in one replica of the database to appropriate changes to achieve the same affect in a different replica. The inventors have recognized and appreciated that as computing devices become more widespread, there will be an increased need or desire for users to maintain multiple copies of databases storing many types of information. There may also be a lesser desire or ability to use the same underlying schema for the replicas on all of the endpoints. For example, portable devices, given that they have limited amounts of memory, may store data about contacts or appointments in a different format than a desktop computer, which has substantially more memory.

The inventors have recognized and appreciated that synchronization of data stored in accordance with different underlying schemas on multiple endpoints may be facilitated if representation of changes to the stored data is abstracted from the underlying schema. Accordingly, a synchronization framework is provided that defines a common set of synchronization metadata that is used to communicate changes between endpoints. This metadata may be exchanged though a synchronization component that may be referred to as a synchronization provider.

The synchronization framework provides a conceptual synchronization model that allows synchronizing data across multiple copies in terms of the model rather than in terms of different schemas. The synchronization model extends the application model by allowing information about changes to be described in terms of entities in the application model. According to the synchronization model, a synchronization component may be able to access changes made to one copy of the data on an endpoint and apply the changes to another copy of the data on a different endpoint in terms of the model if both use the same application model, even though they have different underlying logical schema for data storage.

Moreover, abstracting representation of changes from the underlying schema may allow tracking the changes at a storage level without understanding of the application model operating on top of the stored data. Different data stores may have different underlying mechanisms for change tracking. When these mechanisms are mapped to a common model providing synchronization information, applications may interact with the store regardless of how the changes are tracked within the store.

This may provide improved scalability since a single change may be tracked by the data store once rather than being tracked for each application model implemented over the store. In this way, applications that access replicated data stores may be readily implemented on a platform that supports the synchronization model without special programming to reconcile changes in different formats.

In some embodiments, the synchronization model may comprise functions that allow reading, writing and otherwise manipulating synchronization metadata on changes to the data that is stored along with the data. These functions may accept parameters including entities of the application model to describe data to which the change information applies. A synchronization component or any other suitable component performing data synchronization accesses synchronization information via the functions of the synchronization model. Thus, the synchronization component that performs synchronization such as, for example, a synchronization provider in the Microsoft Sync Framework, does not need to have knowledge of an underlying schema or a mapping between the underlying schema and an application model.

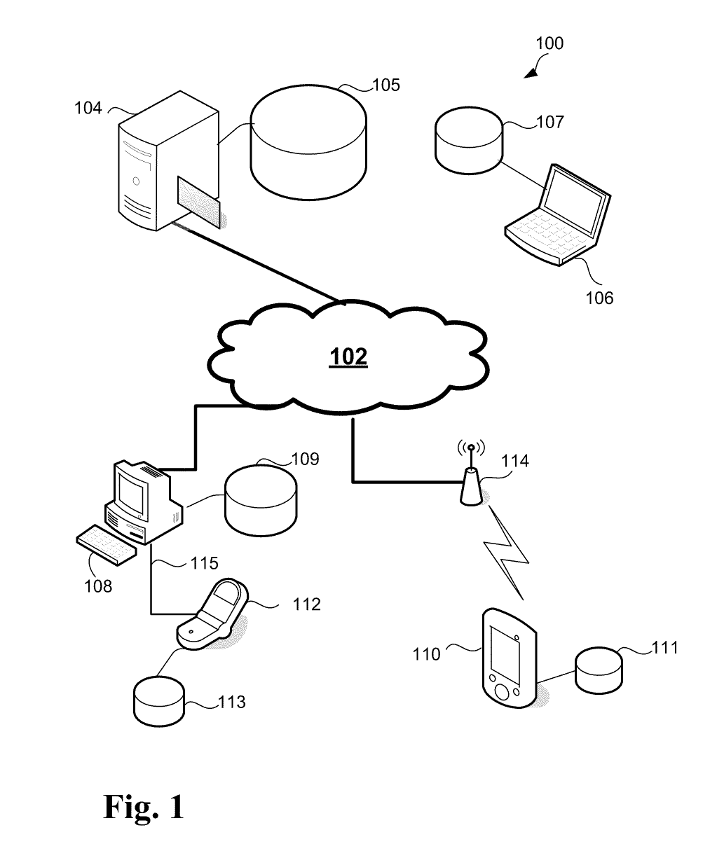

FIG. 1 is a high-level architecture diagram illustrating a computing environment 100 in which some embodiments of the invention may be practiced. FIG. 1 includes a computer network, which may be any suitable single or interconnected communications network, such as Internet 102. FIG. 1 also includes multiple computing devices such as a server 104, a laptop 106, a desktop 108, a personal digital assistant (PDA) 110 and a mobile phone 112 connected to Internet 102 over any suitable computer communications medium, including wired and wireless media. In this example, server 104 may be, for example, an email server. Accordingly, devices 106, 108, 110 and 112 may be client computing devices. However, it should be appreciated that embodiments of the invention are not limited to any particular server.

It should be appreciated that the computing devices 104, 106, 108, 110 and 112, may be endpoints, that each may be configured to store copies of a data such as one or more databases. The data may be of any type. For example, it may be data of interest to an individual, such as information about contacts or appointments. Alternatively or additionally, the data may be data of interest to a business, such as records of sales or inventory. The data may be stored in any suitable format, including custom formats defined by applications that access the data or operating systems that manage data storage on the computing devices.

The devices may be any suitable type of networked computing devices and may be implemented in any suitable combination of hardware and software. For example, the computing devices 104, 106, 108, 110 and 112 may be loaded with software and may execute computer-executable instructions written in any suitable language, including an operating system, such as variants of the WINDOWS® operating system developed by Microsoft Corporation.

Each of the computing devices 104, 106, 108, 110 and 112 may be connected to a network, such as the Internet 102, via either a wired or wireless connection, or a combination thereof. Thus, by way of example only, PDA 102 is shown to wirelessly access Internet 102 via an access point 114. Furthermore, computing devices 104, 106, 108, 110 and 112 may be connected to different networks. For example, mobile phone 112 may not be connected to the Internet 102, but instead may be connected to desktop 108 through, for example, a Bluetooth or USB connection 115, as shown in FIG. 1. In this scenario, desktop 108, in turn, may be connected to Internet 102. It should be noted that these two connections may or may not happen simultaneously. In some embodiments of the invention, devices 104, 106, 108, 110 and 112, operating in a common synchronization environment 100, may be referred to as synchronization partners. The network may be used to exchange information among the devices, including information used to synchronize changes to one copy of a database on one device with copies of the same database maintained by other devices.

At certain points at time, one or more of the devices may become not accessible via Internet 102. For example, if a user of laptop 106 is on airplane or at another location where Internet 102 is not available, laptop 106 may not have connectivity with Internet 102. To illustrate such scenario, in FIG. 1, laptop 106 is shown not to have a connectivity to Internet 102 and, therefore, not in communication with other of the computing devices. Thus, a user of laptop 106 may be able to only access a local copy of the data on laptop 106 and other copies are not available for the reference. This again illustrates that having an up-to-date version of the local data reflecting recent changes to other copies of the data is helpful in providing satisfying user experience. However, it should be appreciated that laptop 106 may be connected to Internet 102 when the user is at a location where connectivity with Internet 102 is available.

In some embodiments of the invention, multiple copies, or replicas, of a database may be distributed to and stored on different computing devices. This may be done for performance, data redundancy (for recoverability) and other purposes. For example, if a hard drive on of the devices malfunctions, desired operations on the data may still be executed since other devices store the copies of the data. Though, multiple copies of a database may be maintained on multiple different devices for any number of reasons, including making the data available for a user when a device is unable to connect to a centralized repository of data, to improve application performance or to minimize cost of communication among the devices. Data may be any suitable data such as a business, personal, financial, legal and other type of data. For example, a user may be accessing his or her account on the FACEBOOK® social network.

In the example of FIG. 1, a user may have an email account with relevant account information stored on server 104. The user may access the email account via different computing devices such as, for example, laptop 106, desktop 108, PDA 110 and mobile phone 112. Consequently, each of the devices 106, 108, 110 and 112 may store a local copy of the account information, including copies of e-mail messages, in a suitable data store. To obtain information on the email account, each device may access its local copy of the database or may access server 104 via Internet 102. Also, the devices 104, 106, 108, 110 and 112 may interact in some way with each other, for example, to share information on changes made to the email account at one of the devices.

If changes are made to a local copy of the data on any of the devices, the changes need to be applied to respective local copies of the data stored on other devices. As an example, if a user updates information on user contacts accessed via the email account while using laptop 106, these updates need to be communicated to the user contacts stored on devices 104, 108, 110 and 112. Conversely, if changes are made to the account information on server 104, those updates may be communicated to the devices 104, 108, 110 or 112 so that they may update their local copies of the database reflecting the e-mail account information.

In the example of FIG. 1, each of the computing devices 104, 106, 108, 110 and 112 contains or otherwise is connected to a respective data store 105, 107, 109, 111 and 113 for storing a local copy of data (e.g., a database) commonly stored on the devices. The data stores may store their respective copies of the data in different underlying schemas. Moreover, different types of data may be stored across the stores and the stores may differ in their syntax, logical storage model(s) and other aspects. Each of the data stores may be any suitable computer storage, such as a file system implemented on any suitable computer storage medium.

Each of the data stores 105, 107, 109, 111 and 113 may store, along with actual stored data, synchronization metadata. The changes may be any suitable manipulations of the stored data such as, for example, deleting, adding, updating the data.

The changes may be made to local copies of the stored data in any suitable way. However, in some embodiments, the changes will be made by application programs executing on each of the devices. For example, an email application executing on a device may manipulate the database representing email account information. It should be noted that the model used to synchronize the data may be different than an application model or a logical storage schema used by one or more applications reading and/or making changes to the data.

The synchronization metadata may comprise information used during synchronization operations. The synchronization metadata, for example, may identify users or other entities that are intended to maintain a synchronized copy of data in the data store. Additionally, the synchronization metadata may indicate when data was last sent to each of the other synchronized users or when data was received from each of the other synchronized users. Additionally, the metadata may convey history information, such as when data was added or modified to the data store. Similarly, synchronization metadata may identify data that has been deleted from the data store and when the deletion occurred. What may be referred to as “tombstones” may be stored to capture information about deleted data. In some embodiments, each of the data stores will have associated with it synchronization metadata of the same type. However, even when data stores have the same types of synchronization metadata, it may not necessarily be the case that the metadata is stored in the same format.

In some embodiments of the invention, the synchronization metadata may be stored separately from the data of the data store. For example, the database may store the data in a form of tables organized as columns and rows, as known in the art. To keep track of changes made to the data and to record related information, in some embodiments of the invention, the database may employ a change tracking mechanism useful in exposing a common synchronization view of the data. In response to a change in the stored data, such as an insertion, deletion or an update, the change tracking mechanism may initiate a respective trigger to write, delete, or add information on the change into a separate storage location, such as, for example, a side table (e.g., a side table of ORACLE® or DB2® database). Such tracking of changes can be performed while having little affect on the actual schema used to store the data. Furthermore, the change tracking may employ timestamps which may reduce impact of change tacking on overall system performance. The timestamps may be used to keep track of timing (e.g., a date and a time) of the changes made to tables of the database.

To enable available, redundant, distributed access to data stored across data stores 105, 107, 109, 111 and 113 with a low latency, some embodiments of the invention provide data synchronization that allows synchronizing the data across the data stores in terms of a common conceptual model. In accordance with a common conceptual model, applications may access data using a logical abstraction. The logical abstraction may incorporate entities or entity sets that map to underlying storage constructs in the data store containing relevant information. For example, an entity, such as a calendar appointment, may be specified as part of the conceptual model. A calendar appointment may have, as just one example, 20 fields of information. Such an entity could be stored in a database table as a record containing 20 fields. However, the same information could be stored in computer memory in other ways. For example, an appointment could be stored as a collection of shorter records in multiple tables that are linked. The use of a common conceptual model allows applications to access the data without specifying the underlying data representation. A framework may be employed to map, on each device, operation to be performed on an entity in accordance with the common conceptual model to operations on underlying data as stored on that device.

A similar conceptual model may be used for synchronization information. The model may abstract the synchronization process from details of different underlying schemas and other aspects of storage of copies of the data in the data stores since information required for synchronization is exchanged between different data stores in a common format. Thus, the data stores may be synchronized easier, faster and more correctly.

Accordingly, in some embodiments of the invention, a synchronization model extends data model instances (e.g., description of customers, orders, order details) with additional entity sets, association sets, functions, procedures and the like, to enable viewing/updating synchronization metadata through the same data model. Accordingly, synchronization may be supplied in terms of the model, as opposed to synchronization merely in terms of a logical storage schema. Such a synchronization model enables decoupling of the synchronization model from the storage schema in a manner to enable synchronizing between data stores with substantially different schemas in terms of the common synchronization model. It should be appreciated that the application is isolated from various aspects of implementation of a storage of the data such as a schema, storage model, syntax, types of data and others.

For example, abstract functions for reading and writing to a synchronization partner (i.e., a device which stores another copy of the data) and providing version metadata may be supplied as an extension of an entity model such as an application model. Encapsulating this information as part of the model enables the Entity Framework Synchronization Provider (as well as other components requiring version information) to work entirely in terms of the synchronization model. Tools may automatically map these functions to a variety of store-specific change tracking mechanisms, and developers may provide custom mapping of these functions for custom change-tracking mechanisms or custom mappings within the model. Accordingly, a common storage-schema based change tracking scheme is supplied, which may be shared by multiple models. Moreover, such synchronization model may be exposed as an extension of the application model (e.g., factoring sync extensions into a separate, dependent model).

In a related aspect, the synchronization framework according to some embodiments of the invention defines a common set of synchronization metadata that is employed to communicate changes between endpoints. The synchronization functionality may be exposed for the ADO.NET Entity Framework as an Entity Framework Synchronization Provider. Such synchronization provider operates in terms of an Entity Model comprised of the application's conceptual model extended with additional EntitySets, EntityTypes, and functions for querying, joining, and manipulating synchronization metadata. These same EntitySets, EntityTypes and Functions may be queried directly in order to combine user data with synchronization version metadata, for example, in generating results with synchronization metadata necessary to form a FeedSync payload.

As an example, an application on one endpoint may submit to the entity framework synchronization provider a request for an identification of changes made to a certain type of data since the last synchronization with another endpoint. The entity framework synchronization provider may, regardless of the underlying representation of the data or synchronization metadata, form a FeedSync payload, or other representation of the requested information. The FeedSync payload may contain the changes in a format that will be understood by the other device that may contain both metadata about the changes and the changed data. The changed data may be represented in the common conceptual model for the data. Synchronization metadata may be represented in the common conceptual model for the synchronization process. When the other device receives the FeedSync payload, it can interpret the information and apply it to update its data store and synchronization metadata.

In a related aspect, the design for the Entity Framework Synchronization Provider may involve defining separate levels of abstraction for change tracking at the storage and entity model layers, which may include logic implemented by the Entity Framework Synchronization Provider (i.e., a synchronization component), functionality exposed by the Entity Framework, and functionality Exposed by the data store.

The Entity Framework Synchronization Provider implements queries and function calls to combine synchronization metadata with user data in querying and updating the store. Functionality exposed by the Entity Framework may comprise a common set of functions that the Entity Framework exposes on top of the provider functions for querying and updating synchronization metadata in terms of the Entity Model. These functions in turn call functions or stored procedures, or execute queries against tables or views, exposed by the underlying provider. In this context, the underlying provider may refer to a database or other component that manages the underlying data store.

According to some embodiments of the invention, functionality exposed by a data store may comprise the following:
1) A common set of functions/methods that tools may use to enable change tracking in the data store;
2) A common set of functions that the provider would implement to read/write partner Sync Metadata;
3) A common set of functions that the provider would implement to expose version information in terms of actual storage schema; and
4) A common function for getting the current change version.

It should be appreciated that the functionalities described above of the Entity Framework Synchronization Provider, the Entity Framework and the data store are provided by way of example only as any other suitable respective functionalities maybe provided by these components. Moreover, the synchronization component may be referred to differently from the Entity Framework Synchronization Provider as any suitable component may be utilized that implements embodiments of the invention. Similarly, other suitable components(s) may be employed to implement functionality of the Entity Framework.

In a related aspect, functions exposed by a provider of the database may be actual functions defined within the data store or “virtual” functions defined, for example, through Defining Queries in the Storage Metadata Schema (SSDL). The Entity Framework metadata definitions may be extended with attributes to correlate functions with the corresponding entity sets/association sets, and the metadata objects may be extended to expose this information through the model.

Referring back to FIG. 1, each of the data stores 105, 107, 109, 111 and 113 may comprise or be otherwise associated with a respective synchronization metadata store that stores information related to changes to data in the data store. Such information may be used to synchronize the data between the data stores. As discussed above, data stores 105, 107, 109, 111 and 113 may keep track of the changes made to their respective database in such a way that actual schemas of the databases are little or not at all affected.

The entity framework synchronization provider may be used to implement any of multiple types of synchronization between or among any number of endpoints. In some embodiments of the invention, different types of data synchronization may be performed across multiple endpoints storing copies of the data. In a so-called one-way synchronization, a changes to the data may be made via a single device while others operate as “read only” devices, with the changes being propagated to the devices from the single device. This may occur, for example, when a user of the device is a traveling salesman who retrieves published data; for example, a catalog of products and prices updated daily.

In another scenario, which may be referred to as a two-way synchronization, changes to each copy of the data may be made locally on each respective device, or endpoint. However, information on all of the changes, via a data synchronization according to some embodiments of the invention, is communicated to a single device that propagated the changed to other devices. This type of synchronization may be illustrated with s system shown in FIG. 1 where e-mail server 104 may act as a master through which the data synchronization across the devices is performed.

As yet another example, a synchronization environment such as, for example, environment 100 may implement a peer-to-peer data synchronization, where each two endpoints may synchronize data among each other. For example, laptop 106 and desktop 108 shown in FIG. 1 may exchange information for data synchronization.

A description of an example implementation of data synchronization according to some embodiments of the invention is provided below.

A “Model-based Sync Provider” (i.e., a synchronization component) represented as the “Entity Framework Synchronization Provider,” which may perform operations such as enumerate changes, apply changes, and return other sync information, including the members and information known by members in the sync environment (e.g., “Sync Partners” or “Replicas”). Likewise, a “Model-based Persistence Framework” (represented by the Entity Framework) which exposes the ability to query and update a conceptual model that is mapped to a storage schema (i.e., a relational database). Moreover, an “Application-oriented Conceptual Model” may be employed to define the model that the Model-based Persistence Framework exposes, and which the application (and other components, including the Model-based Sync Provider) employ to interact with the store. Such Model includes information specifying how it is mapped to a specific storage schema, and may be created by hand, by a tool, generated at runtime, and the like. In one aspect of the present invention, such is persisted as XML. Such components interact through the following series of actions:

Setup Stage:

During the setup stage, each of the devices that will be synchronized in accordance with the entity framework synchronization provider is designed to operate with other compatible devices. This design may take the form of developing software applications or services, such as a database management service, that will be installed on the devices in operation. Events that may happen at the setup stage may include:

S0) Developer or tool ensures (creates or verifies) storage for synchronization information, or metadata, such as information about other replicas in the synchronization relationship, version information, tombstones, etc.

S1) Developer defines application conceptual model (Entity Data Model) and mapping to a data source;

S2) Developer or tool extends conceptual model to expose common functionality necessary to:
a) Obtain version information for an extent (i.e., an EntitySet) within the conceptual model,
b) Read and write the synchronization information, or metadata. Such functionality may be exposed as functions, procedures, queries, methods, tables, views, and the like.

S3) Developer or tool enables some change tracking mechanism in the data store to expose current local version information, possibly including some combination of:
a) Built-in change tracking,
b) RowVersion columns,
c) UniqueIdentifier columns,
d) Triggers,
e) Functions or Procedures, and
f) Tables, Views.

S4) Developer or tool maps the synchronization information to the store-specific change tracking mechanisms

Runtime: Change tracking

After software or other components that implement the entity framework synchronization provider components for the devices that will be synchronized in operation, those devices may be operated by their respective user or users. Each device may contain a copy of the data store that, in operation, is changed from time to time. Initially, each device may track changes made to its data store.

CT1) A change (insert, update, delete) is made to the store, for example, through the application conceptual model extended with synchronization metadata, an alternate application conceptual model, or to the store directly;

CT2) Store-specific mechanisms (S3) record local change information in store-specific manner.

Runtime: Querying Synchronization Information

At some point, one or more of the devices may initiate a synchronization function. The synchronization function may be initiated in response to any suitable event. In some embodiments, synchronization may be initiated when a device obtains network connectivity or detects that one of its synchronization partners has connected to the network. Regardless of the manner in which a synchronization operation is initiated, one or more of the synchronization partners to participate in the synchronization operation may query synchronization information, which may, for example, include the following acts:

QC1) Request comes in to “Model-based Sync Provider” (EntityFramework SyncProvider) to EnumerateChanges since some point in time.

QC2) Model-based Sync Provider queries exposed extended model to combine some combination of synchronization version and partner information with local version information (exposed through standard means) to determine what has changed (for example, since a “high water mark”) and returns some combination of:

a) Synchronization Information (i.e., version information exposed in act S2 above )

b) Data (i.e., the data for the entities w/in the application's conceptual model in act S1 above)

QC2b) Other components, applications, tools may query and access the same information.

QC3) The “Model-based Persistence Framework” (i.e., Entity Framework) uses the mapping specified in S4 to translate the common synchronization requests (and results) defined in S2 to store-specific mechanisms defined in S3

Runtime: Applying Changes

Once synchronization information is obtained from one of the synchronization partners, it may be applied to one or more of the other synchronization partners. In some embodiments, one synchronization partner will query its database for synchronization information and all other synchronization partners may apply the changes described by that synchronization information. Such a series of steps, for example, may occur during one-way synchronization. Alternatively, all synchronization partners may generate synchronization information that is distributed to all other synchronization partners. Each synchronization partner may then apply the changes described in the synchronization information received from its partners. Such a sequence of events may occur, for example, when two-way synchronization is employed. Accordingly, one or more of the synchronization partners may apply changes based on synchronization information obtained from one or more other partners. The changes may be applied, for example, according to acts that may include:

AC1) A request comes in to the Model-based Sync Provider to apply changes made by an external partner

AC2) The Model-based Sync Provider writes changes through the application conceptual model S1

AC2b) The Model-based Persistence Framework applies changes to the store according to the mapping defined in S1

AC3) The Model-based Sync Provider records synchronization information (for example, partner version information) through the mechanisms defined in S2.

AC3b) The Model-based Persistence Framework persists the synchronization information according to the storage-specific mapping defined in S4.

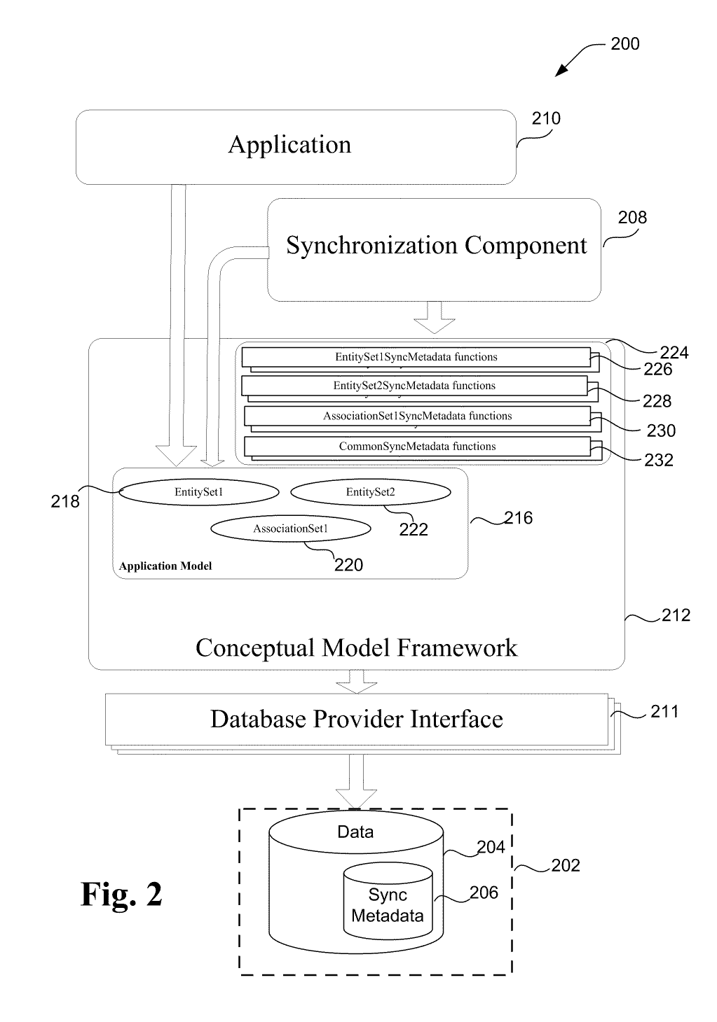

It should be appreciated that the above description is provided by way of example only. FIGS. 2-4 illustrate exemplary components implementing data synchronization according to some embodiments of the invention.

FIG. 2 is a block diagram illustrating an endpoint 200 comprising components implementing data synchronization according to some embodiments of the invention. Endpoint 200 may be any suitable computing device such as, for example, any of the computing devices 104, 106, 108, 110 and 112 shown in FIG. 1.

In this example, endpoint 200 comprises a data source 202 which is shown with a dotted line to emphasize that it may include any suitable data storage components. In FIG. 2, data source 202 comprises actual data 204 (e.g., a data store or database) in an underlying schema. The schema may be specific to endpoint 200 in a way that it may be different from underlying schemas in accordance with which copies of the data are stored on other devices. Data source 202 may also comprise synchronization metadata storage shown by way of example only as “sync metadata” 206. Sync metadata 206 stores synchronization metadata on changes made to the data stored in data 204. As discussed above, an application developer or any suitable computation tool may enable a change tracking mechanism within data source 202 whereby a record of changes to data 204 such as, for example, updates, insertions and deletions, and/or metadata, for example who made the change, when, or why, may be recorded in sync metadata 206. The change tracking mechanism may comprise built-in change tracking, RowVersion columns, UniqueIdentifier columns, triggers, functions or procedures, tables, views and timestamps.

Synchronization component 208 may be a component that manages a synchronization process. For example, synchronization component 208 may detect conditions under which synchronization may be performed. Synchronization component 208, when synchronization is to be performed, may query its underlying data source 202 for changes which may be distributed as synchronization information to synchronization partners. Alternatively or additionally, synchronization component 208 may apply to its underlying data source 202 changes based on synchronization information obtained from other synchronization partners. To obtain or apply synchronization information, synchronization component interacts with the underlying data source 202 through a synchronization model 224.

Synchronization model 224 provides, in response to requests, information on changes in the data, in a common format recognized by different devices in synchronization relationship with endpoint 200, regardless of underlying schemas used to store the data by. As shown above, Synchronization Component 208 may be referred to as a “Model-based Sync Provider” to emphasize that data synchronization is performed in terms of a model rather than in terms of an underlying data storage schema. Synchronization Component 208 may be regarded as the Entity Framework Synchronization Provider. Synchronization Component 208 may perform operations such as enumerate changes, apply changes, and return other synchronization information, including information on other members (referred to as “synchronization partners”) of the synchronization environments and information known by the members.

In the embodiment illustrated in FIG. 2, synchronization model 224 is exposed by a conceptual model framework 212, for example, the ADO.NET Entity Framework. In addition to providing a synchronization model 224, conceptual model framework may include an application model 216. Application model 216 may provide mechanisms for accessing data 204 in the format of underlying data source 202 using functions in a format that is independent of the representation of data in data source 202. Synchronization model 224 may provide an analogous set of functions to synchronization component 208 whereby the functions provided by synchronization model 224 allow synchronization information to be read or written to the underlying data source 202.

In FIG. 2, application 210 may access, data 204 in data source 202. Application 210 accesses data 204 via a conceptual model framework 212 that provides a conceptual representation of the data in data 204. For this purpose, conceptual model framework 212 comprises application model 216.

Application model 216 may be defined in terms of various logical entities and their relationships. In FIG. 2, application model 216 is shown by way of example only to comprise EntitySet1 218 and EntitySet2 222 representing respective entities within data 204, and AssociationSet 220 representing relationships between these entities. These exemplary entities are used to represent the stored data in terms understood by application 210 which may be any suitable business, financial, social network or other application. These entity sets may include functions that allow application 210 to access the underlying data 204 in terms of the entity sets and their associations.

The functions of the application model, when executed, may interact with the underlying data source 202 through database provider interface 211 (which may, for example, be an ADO.NET Data Provider). Database provider interface 211 may expose functions that allow the conceptual model framework 212 to read and write data to data source 202.

A similar approach may be used for implementing synchronization model 224. As discussed above, application model 218 may be extended (e.g., by an application developer or by a suitable tool) to expose common synchronization information, via synchronization model 224. The synchronization metadata, may be recorded in a data source specific manner as sync metadata 206 within data source 202. This synchronization metadata may be exposed through the synchronization model 224 as synchronization information in a common format, to provide version information for each EntitySet within data 204, information about other replicas in the synchronization relationship, and any other suitable information. Such functionality can be exposed as functions, procedures, queries, methods, tables, views, and other features. For example, additional EntitySets, EntityTypes, and functions for querying, joining, and manipulating synchronization metadata may be provided within synchronization model 224.

In some embodiments of the invention, decoupling of the underlying data storage from the application model, via the synchronization model, may allow employing different and/or evolving synchronization logic without having to change data storage schema and the application model. Moreover, exposing sync information through model enables querying across (i.e., joining) application and synchronization data to get application data, along with synchronization information, that meets a particular criteria according to both the synchronization and application data, in a single query.

A synchronization model in accordance with some embodiments of the invention may comprise functions that allow accessing synchronization metadata on changes to the data in terms of changes to the logical entities defined by the application model. Thus, FIG. 2 shows that synchronization model 224 may comprise functions 226, 228, 230, 232 that allow logical representation of synchronization metadata 206. Thus, in the example in FIG. 2, the functions 224 may comprise: EntitySet1SyncMetadata functions 226 representing synchronization information on changes to EntitySet1 218; EntitySet1SyncMetadata functions 228, representing synchronization information on changes to EntitySet2 222; and AssociationSetSyncMetadata functions 230, representing synchronization information on changes AssociationSet 220. In addition, functions 224 may comprise CommonSyncMetadata functions 232, representing any other suitable synchronization information that is not tied to a specific entity set in application model 216. It should be recognized that FIG. 2 illustrates four groups of functions; one group of functions represents information not associated with a specific entity set or association set in the application model, and the remaining three groups of functions are associated with a corresponding entity set or association set of application model 216. Any number of entity sets or association sets may be present in application model 216. Accordingly, it should be appreciated that three such entity or association sets are shown for simplicity of illustration, but any suitable number may be present. Also, it should be recognized that there may be any suitable number of functions within each set of functions. There may be, for example, one or more functions for querying data source 202 to obtain synchronization information. There may additionally be one or more functions for each entity for applying synchronization information to data source 202.

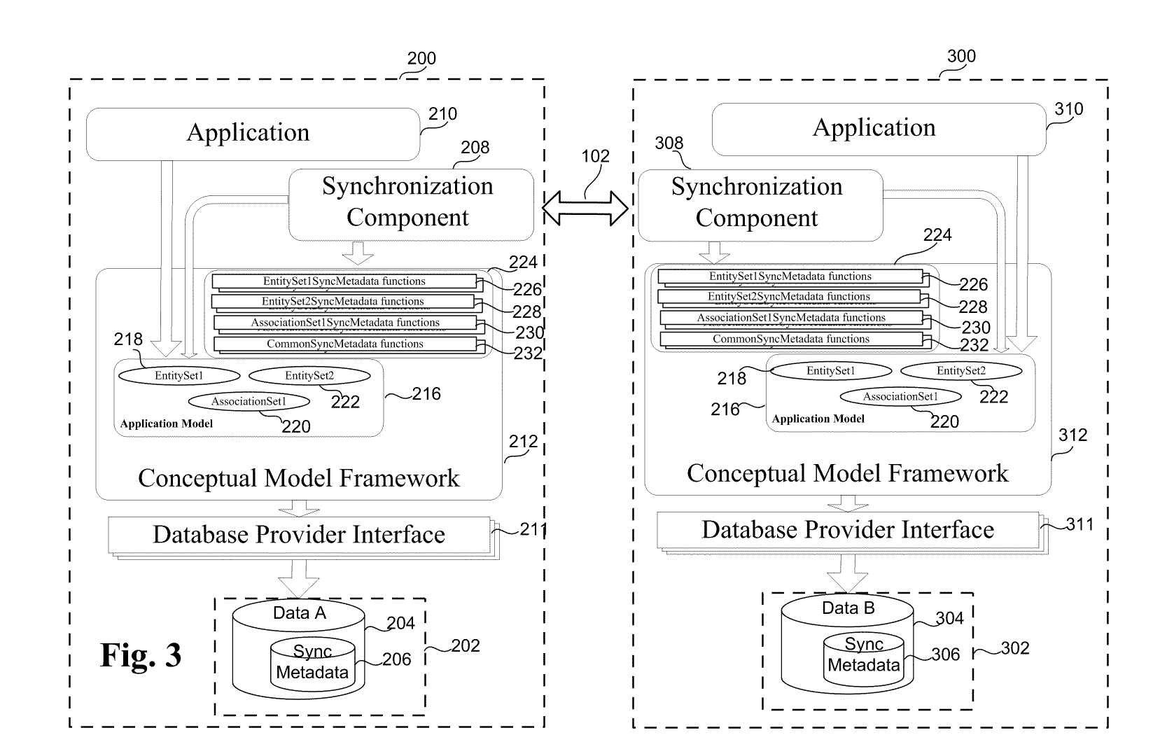

Multiple devices, or endpoints, (e.g., server 104, laptop 106, desktop 108, PDA 110 and mobile phone 112 shown in FIG. 1 may operate in a common synchronization environment where each of the devices stores a copy of a data such as a database and participates in a synchronization of changes to the data across the devices. Each of the devices may have a conceptual model framework, such as the ADO.NET Entity Framework. The devices may each use their own conceptual model framework as they interact as synchronization partners. FIG. 3 is a block diagram illustrating a second device, endpoint 300, configured to act as a synchronization partner with endpoint 200.

In FIG. 3, endpoint 200 (which may represent any of the endpoints described in connection with FIG. 1) is shown to operate in a common synchronization environment with an endpoint 300, which may be implemented on a different computing device. Components similar across the systems are shown by the same numerical reference.

In this example, data 204 is shown by way of example as data store A and data 304 is shown by way of example as data store B. This may illustrate that data source 202 may store a copy of the data 204 in an underlying schema different from that used to store another copy 304 of the data in a different underlying schema on data source 302. Additionally, data sources 202 and 302 may have synchronization metadata recorded in different formats, which is illustrated as sync metadata 206 and sync metadata 306, respectively. Similarly, a different data provider interface 311 may act as an interface between conceptual model framework 312 and data source 302 is used to interface between conceptual model framework 212 and data source 202.

FIG. 3 illustrates that, though endpoints 200 and 300 have underlying data sources in different formats, each can have the same application model 216 and synchronization model 224, allowing applications at either endpoint to access data in a common application model and allowing synchronization components, such as synchronization components 208 and 308, to access synchronization metadata through a common synchronization model.

In the embodiment illustrated in FIG. 3, application 210 may access data source 202 on endpoint 200, from time to time making changes to data source 202. Access to data source 202 may be through application model 216, through an alternate application model, or directly to the data source 202. Similarly, application 310 on endpoint 300 may access data source 302 through a copy of application model 216 on endpoint 300, through an alternate model, or directly to the data source 302.

From time to time, an event may occur, triggering synchronization between endpoints 200 and 300. As noted above, any suitable event, such as user input or connection of a device to a network, may trigger synchronization. Also as noted above, any suitable type of synchronization may be performed, such as one way synchronization or two way synchronization. Synchronization components 208 and 308 may be programmed to determine when synchronization is to occur and the type of synchronization. Regardless of the type of synchronization, at least one of synchronization components 208 or 308 will access synchronization metadata through its associated synchronization model 224, possibly along with the associated modified application data exposed through application model 218. The synchronization metadata will be provided to the requesting synchronization component in a format specified by the synchronization model 224, possibly along with the associated modified data in a format specified by application model 218.

The synchronization metadata and associated modified data may be provided from the requesting synchronization component to a receiving synchronization component. The synchronization metadata and associated modified data may be provided, for example, over network 102. The receiving synchronization component, because it has a synchronization model and an application model that manipulate data in the same format as the initiating synchronization component, may apply the received data modifications and synchronization metadata through its own application model and synchronization model, respectively. Through the synchronization model, the synchronization metadata may be applied to synchronize the data source in the receiving endpoint with the data source in the initiating end point. These operations may be performed regardless of the underlying representation of the data or the means of tracking changes to the underlying data. Moreover, if the specific synchronization operations to be performed change over time, the change can be effected by changing the operation of one or more the synchronization components, such as synchronization component 208 or 308. Thus, as can be seen, conceptual model framework incorporating a synchronization model provides substantial flexibility in implementing synchronization operations in a distributed system.

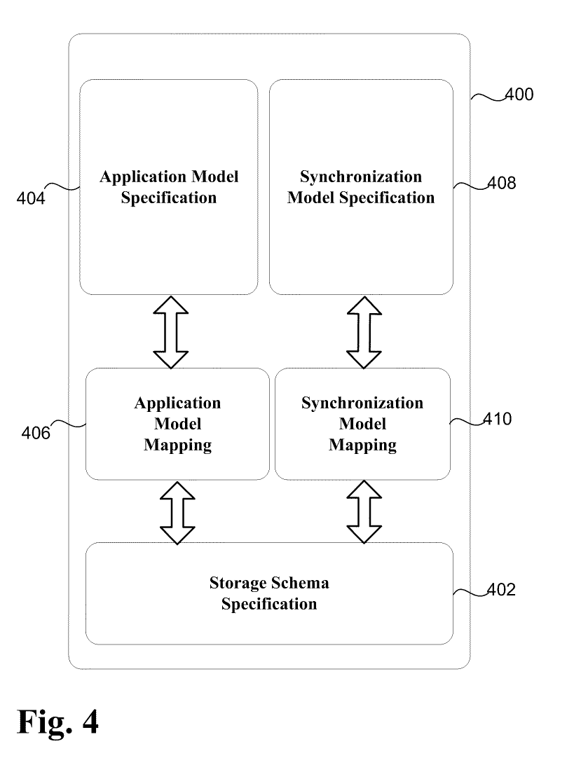

FIG. 4 is a block diagram illustrating metadata according to some embodiments of the invention. FIG. 4 illustrates metadata 400 comprising components which implement data synchronization. Metadata 400 may be located in any suitable computing device such as, for example, one of devices 104, 106, 108, 110 and 112 shown in FIG. 1. Thus, storage schema specification 402 comprises a format, or a schema, according to which data is stored in a data store. It should be appreciated that storage schema specification 402 may comprise various other information on storage of the data such as a storage model, syntax, types of data and others.

When a change is made to the data store (e.g., an insertion, an update or a deletion), a store-specific mechanisms may record local change information in a store-specific manner. For example, triggers and timestamps as discussed above may be used to record relevant information upon changes in the stored data. The changes may be stored in any suitable data storage such as, for example, metadata 206 in data store 202. In some embodiments, side tables may be used to store the changes in a database while in other embodiments the change information may be stored co-located with the data that has changed.

In FIG. 4, application model specification 404 defines a conceptual application model which provides a conceptual representation of the stored data. The application model comprises various conceptual entities, associations, and functions representing entities, entity relationships and functions within the data. Application model mapping 406 provides, as the name implies, mapping of application model specification 404 to the data store as described by storage schema specification 402. The mapping 406 may be created by a developer, by a suitable computational tool, or in any other suitable way.

As discussed above, in some embodiments of the invention, application model specification 404 is extended to expose, in a common format, synchronization information that is used to synchronize replicas of data stored on multiple devices in synchronization relationship to each other. Such format, expressed for example as various functions, entity sets, and association sets to read, write and otherwise manipulate changes to the data, is provided as a synchronization model.

Accordingly, synchronization model specification 408 shown in FIG. 4 defines the synchronization model comprising synchronization information. As discussed above, the synchronization information may be exposed as functions, procedures, queries, methods, tables, views, and in other ways. As shown in FIG. 4, synchronization model mapping 410 maps the synchronization information in synchronization model specification 408 to the store-specific change tracking mechanisms described by storage schema specification 402.

Synchronization model specification 408 and synchronization model mapping 410 allow synchronization of the data to be performed in terms of a common model rather than in terms of an underlying data schema, for example as described by storage schema specification 402.

It should be appreciated that, in FIG. 4, synchronization model specification 408 is shown separately from application model specification 404 simply for the purpose of illustrating these components. As discussed above, the synchronization model may be an extension of the application model and components implementing the model may be located in any suitable relationship with respect to each other. However, it should also be appreciated that, in embodiments of the invention, additional application models may exist that operate separately from the application model 404 over the same storage schema 402, which allows decoupling the application model and synchronization model used to synchronize data from the underlying schema. Moreover, it provides flexibility in a sense that common data underlying different application models overlaying a common data storage may be synchronized through the same synchronization model.

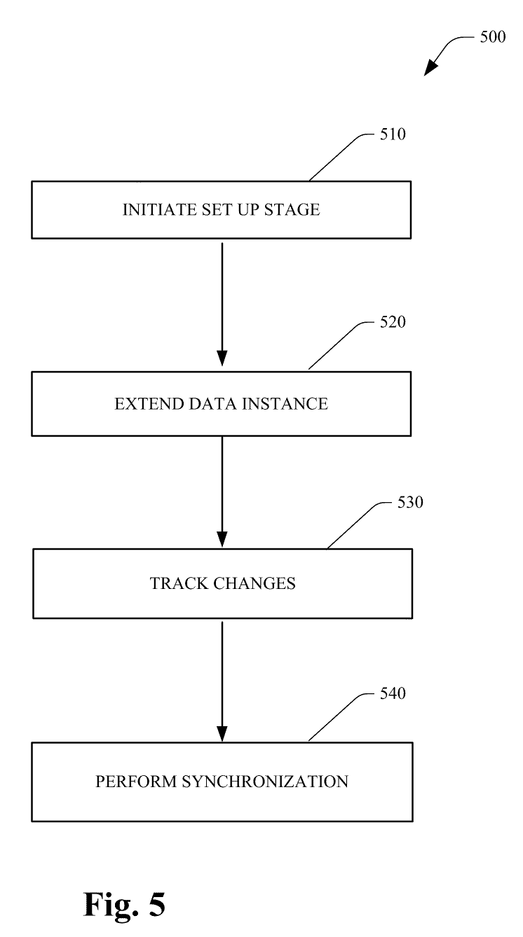

FIG. 5 illustrates a methodology 500 according to one embodiment of the invention. While the exemplary method is illustrated and described herein as a series of blocks representative of various events and/or acts, embodiments of the invention are not limited by the illustrated ordering of such blocks. For instance, some acts or events may occur in different orders and/or concurrently with other acts or events, apart from the ordering illustrated herein, in accordance with some embodiments of the invention. In addition, not all illustrated blocks, events or acts, may be required to implement a methodology in accordance with some embodiments of the invention. Moreover, it will be appreciated that the exemplary method and other methods according to some embodiments of the invention may be implemented in association with the method illustrated and described herein, as well as in association with other systems and apparatus not illustrated or described. Initially, at 510, a set up stage may be supplied, wherein a developer may define an application conceptual model and associated mapping to a data source. Subsequently, at 520, data instances may be extended, wherein such enables the synchronization to be supplied in terms of the model, as opposed to synchronization merely in terms of the schema. At 530, the changes may be tracked and synchronization associated therewith performed at 540. Such enables decoupling of the data model from the storage schema in a manner to enable synchronizing between stores with substantially different schemas in term of the common model. For example, abstract functions for reading and writing synchronization partner and version metadata may be supplied as an extension of the entity model.

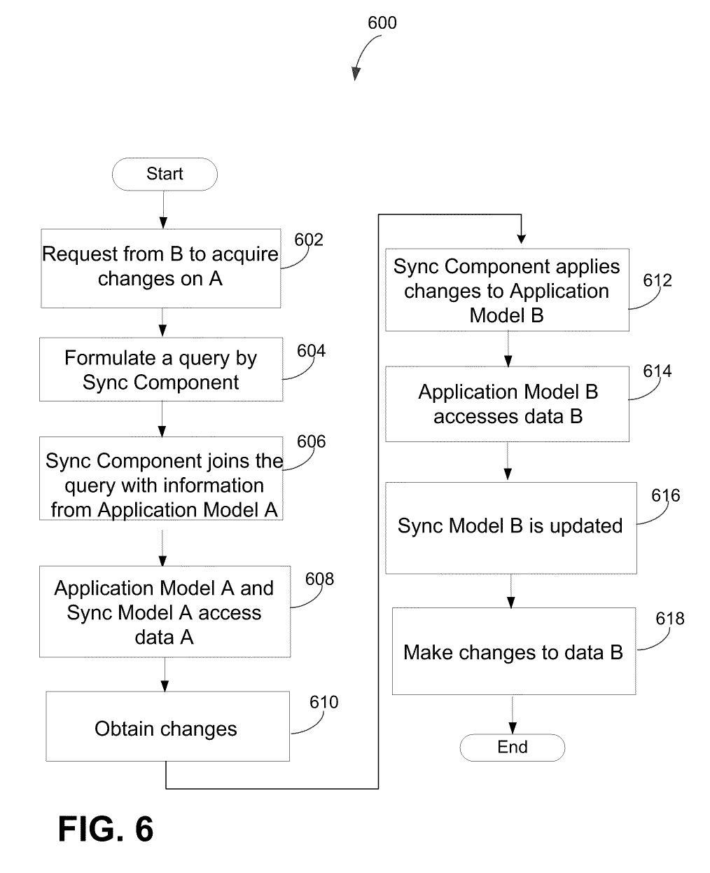

FIG. 6 is a flowchart providing exemplary details of a process 600 of synchronization of data between two endpoints, referred to by way of example only as endpoints A and B, according to one embodiment of the invention. Endpoints A and B, as one example, may be endpoints 200 and 300 (FIG. 3). However, any suitable endpoints may be involved in a synchronization operation as illustrated in FIG. 6.

The process of FIG. 6 may be implemented in software executed by any suitable computing device. Process 600 may start at any suitable point at time. Thus, the software implementing the process may be launched automatically, for example, at a determined time, such as at first boot-up of the computing device, or it may be explicitly invoked by a user, such as in a configuration settings module for an operating system loaded on the computing device. Also, the software may be launched in response to a change in a data stored in data store of the computing device or in response to any other event. Process 600 may be executed on each of the endpoints which each store copies of the same data and are in synchronization relationship with respect to the data.

At block 602, endpoint B may request, for example, via a synchronization component, to enumerate changes made to a copy of the data stored on endpoint A. Endpoint A may store the data in any suitable component such as, for example, on data source 202 as shown in FIGS. 2 and 3. The request may include criteria for desired information on the changes, such as, for example, who made the change and at what time or any other suitable criteria. It should be appreciated that the request to enumerate the changes may be provided by any other suitable component or may be initiated by a user or automatically.

At block 604, the synchronization component may formulate a query against an exposed model such as synchronization model 224 of endpoint 200 shown in FIG. 2. Functions within synchronization model 224 may provide information on changes in a common format so that changes to data stores of endpoints A and B may be synchronized without knowledge of the respective underlying schemas used to store or track changes to the data. A component performing the synchronization on endpoint A (e.g., conceptual model framework 212) may utilize functions 224 (e.g., in synchronization model specification 408) and data in application model specification 404 to formulate a query that returns synchronization information describing a particular set of changes.

At block 606, the synchronization component may join synchronization information on the changes in the data with the actual data that has been changed, in accordance with the criteria provided with the request. Because the actual data is represented through a conceptual model (e.g., an entity sets, association sets and other entities), the synchronization component can join information in the query with information provided by an application model A (e.g., application model 216 or application model specification 404) and synchronization model A (e.g., synchronization model 224 or synchronization model specification 408) used to access the data store on endpoint A. It should be noted that respective processes at blocks 604 and 606 may be done as a single operation.

At block 608, application model A, extended by synchronization model A, accesses, via a mapping (e.g., application model mapping 406 and synchronization model mapping 410), the data A and associated sync metadata stored in an underlying schema that may be different from an underlying schema used to store another copy of the data, data B and associated sync metadata, on endpoint B.

At block 610, changes may be obtained as a result of the query which may comprise synchronization information (e.g., information on a version of the data A, additions, deletions and updated to the data) along with the actual data that has changed (e.g., what data has been added to the data A, what has been deleted or otherwise modified). The result may be provided in a format common to that of synchronization model specification on endpoint B (e.g., functions 224B show in FIG. 3). Accordingly, in some embodiments, conceptual model framework 212 as shown in FIGS. 2 and 3 may use synchronization model specification 408 and the mapping specified, for example, in synchronization model mapping 410 to translate the synchronization requests and results to formats specific to a particular data storage.

At block 612, the synchronization component may apply the changes, in a common format, to application model B. At block 614, application model B accesses a copy of the data as data store B, via a mapping between entities and their relationships within the application model. At block 616, the synchronization component may update the synchronization metadata, in a common format, to synchronization model B. Thus, at block 616, synchronization model B on endpoint B (e.g., synchronization model 314 in FIG. 3) may be updated in accordance with the changes. Thus, synchronization information on changes in the copy of the data stored on endpoint A is applied to the copy of the data stored on endpoint B in terms of the application model. The mapping allows translating the synchronization information in a common format into a format (e.g., an underlying storage schema, syntax, data type, etc.) specific to data store B. Consequently, at block 618, changes may be made to the data on data store B. It should be appreciated that processes shown in FIG. 6 may be performed in an order different from that shown in FIG. 6.

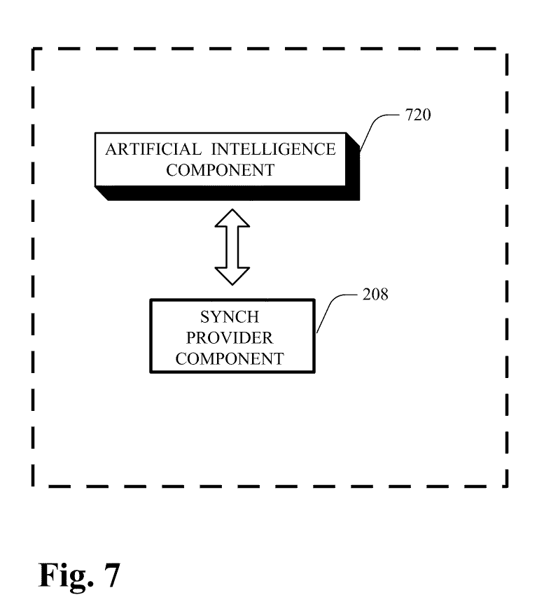

FIG. 7 illustrates an artificial intelligence (AI) component 430 that may be employed to facilitate inferring and/or determining when, where, how to manage synchronization according to some embodiments of he invention. As used herein, the term “inference” refers generally to the process of reasoning about or inferring states of the system, environment, and/or user from a set of observations as captured via events and/or data. Inference may be employed to identify a specific context or action, or may generate a probability distribution over states, for example. The inference may be probabilistic—that is, the computation of a probability distribution over states of interest based on a consideration of data and events. Inference may also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

The AI component 720 may employ any of a variety of suitable AI-based schemes as described supra in connection with facilitating various aspects of the herein described invention. For example, a process for learning explicitly or implicitly how to perform synchronization may be facilitated via an automatic classification system and process. Classification may employ a probabilistic and/or statistical-based analysis (e.g., factoring into the analysis utilities and costs) to prognose or infer an action that a user desires to be automatically performed. For example, a support vector machine (SVM) classifier may be employed. Other classification approaches include Bayesian networks, decision trees, and probabilistic classification models providing different patterns of independence may be employed. Classification as used herein also is inclusive of statistical regression that is utilized to develop models of priority.

Further, some embodiments of the inventions may employ classifiers that are explicitly trained (e.g., via a generic training data) as well as implicitly trained (e.g., via observing user behavior, receiving extrinsic information) so that the classifier is used to automatically determine according to a predetermined criteria which answer to return to a question. For example, with respect to SVM's that are well understood, SVM's are configured via a learning or training phase within a classifier constructor and feature selection module. A classifier is a function that maps an input attribute vector, x=(x1, x2, x3, x4, xn), to a confidence that the input belongs to a class—that is, f(x)=confidence (class).

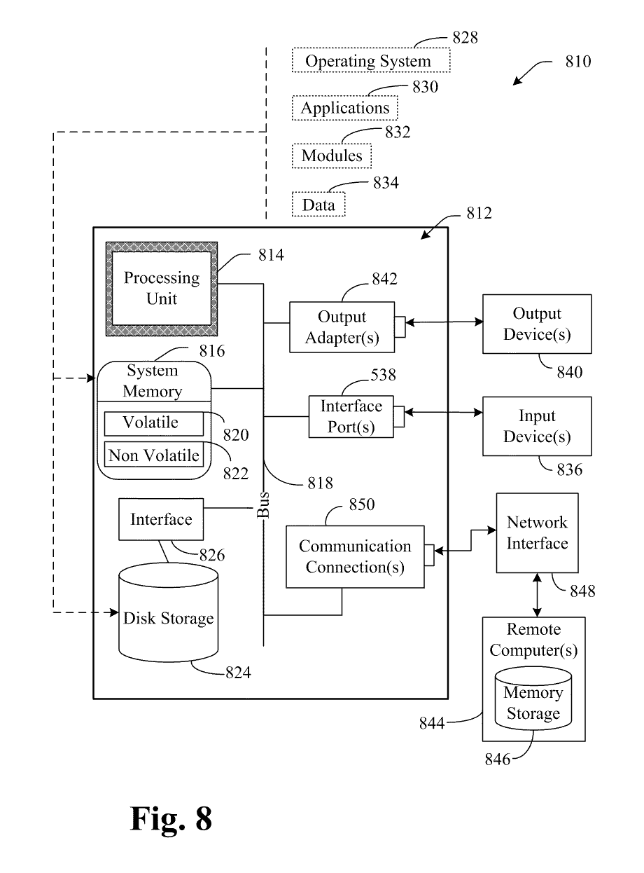

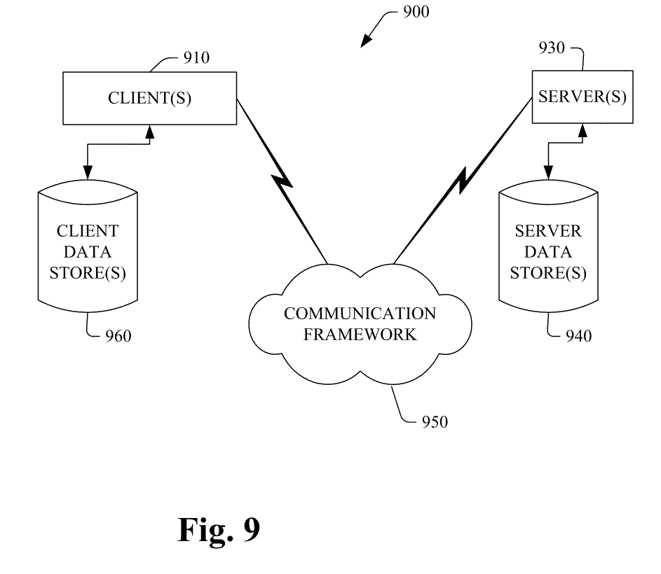

In order to provide a context for the various aspects of the disclosed subject matter, FIGS. 8 and 9 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the invention also may be implemented in combination with other program modules. Generally, program modules include routines, programs, components, data structures, etc. that performs particular tasks and/or implements particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the invention may be practiced on stand-alone computers. In a distributed computing environment, program modules may be located in both local and remote memory storage devices.

As used in this application, the terms “component”, “system”, “engine”, model are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server may be a component. One or more components may reside within a process and/or thread of execution, and a component may be localized on one computer and/or distributed between two or more computers.

Generally, program modules include routines, programs, components, data structures, and the like, which perform particular tasks and/or implement particular abstract data types. Moreover, those skilled in the art will appreciate that the innovative methods may be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some embodiments of the invention may be practiced on stand-alone computers. In a distributed computing environment, program modules may be located in both local and remote memory storage devices

With reference to FIG. 8, an exemplary environment 810 for implementing various aspects described herein includes a computer 812. The computer 812 includes a processing unit 814, a system memory 816, and a system bus 818. The system bus 818 couple system components including, but not limited to, the system memory 816 to the processing unit 814. The processing unit 814 may be any of various available processors. Dual microprocessors and other multiprocessor architectures also may be employed as the processing unit 814.

The system bus 818 may be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 816 includes volatile memory 820 and nonvolatile memory 822. The basic input/output system (BIOS), containing the basic routines to transfer information between elements within the computer 812, such as during start-up, is stored in nonvolatile memory 822. By way of illustration, and not limitation, nonvolatile memory 822 may include read only memory (ROM), programmable ROM (PROM), electrically programmable ROM (EPROM), electrically erasable ROM (EEPROM), or flash memory. Volatile memory 820 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 812 may also include removable/non-removable, volatile/non-volatile computer storage media. FIG. 8 illustrates, for example, a disk storage 824. Disk storage 824 includes, but is not limited to, devices like a magnetic disk drive, floppy disk drive, tape drive, Jaz drive, Zip drive, LS-100 drive, flash memory card, or memory stick. In addition, disk storage 824 may include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 824 to the system bus 818, a removable or non-removable interface is typically used such as interface 826.

It is to be appreciated that FIG. 8 describes software that acts as an intermediary between users and the basic computer resources described in suitable operating environment 810. Such software includes an operating system 828. Operating system 828, which may be stored on disk storage 824, acts to control and allocate resources of the computer system 812. System applications 830 take advantage of the management of resources by operating system 828 through program modules 832 and program data 834 stored either in system memory 816 or on disk storage 824. It is to be appreciated that various components described herein may be implemented with various operating systems or combinations of operating systems.

A user enters commands or information into the computer 812 through input device(s) 836. Input devices 836 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 814 through the system bus 818 via interface port(s) 838. Interface port(s) 838 include, for example, a serial port, a parallel port, a game port, and a universal serial bus (USB). Output device(s) 840 use some of the same type of ports as input device(s) 836. Thus, for example, a USB port may be used to provide input to computer 812 and to output information from computer 812 to an output device 840. Output adapter 842 is provided to illustrate that there are some output devices 840 like monitors, speakers, and printers, among other output devices 840 that require special adapters. The output adapters 842 include, by way of illustration and not limitation, video and sound cards that provide a means of connection between the output device 840 and the system bus 818. It should be noted that other devices and/or systems of devices provide both input and output capabilities such as remote computer(s) 844.

Computer 812 may operate in a networked environment using logical connections to one or more remote computers, such as remote computer(s) 844. The remote computer(s) 844 may be a personal computer, a server, a router, a network PC, a workstation, a microprocessor based appliance, a peer device or other common network node and the like, and typically includes many or all of the elements described relative to computer 812. For purposes of brevity, only a memory storage device 846 is illustrated with remote computer(s) 844. Remote computer(s) 844 is logically connected to computer 812 through a network interface 848 and then physically connected via communication connection 850. Network interface 848 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 850 refers to the hardware/software employed to connect the network interface 848 to the bus 818. While communication connection 850 is shown for illustrative clarity inside computer 812, it may also be external to computer 812. The hardware/software necessary for connection to the network interface 848 includes, for exemplary purposes only, internal and external technologies such as, modems including regular telephone grade modems, cable modems and DSL modems, ISDN adapters, and Ethernet cards.

FIG. 9 is a block diagram of a computing environment 900 in which some embodiments of the invention may be implemented. The system 900 includes one or more client(s) 910. The client(s) 910 may be hardware and/or software (e.g., threads, processes, computing devices). The system 900 also includes one or more server(s) 930. The server(s) 930 may also be hardware and/or software (e.g., threads, processes, computing devices). The servers 930 may house threads to perform transformations by employing the components described herein, for example. One possible communication between a client 910 and a server 930 may be in the form of a data packet adapted to be transmitted between two or more computer processes. The system 900 includes a communication framework 950 that may be employed to facilitate communications between the client(s) 910 and the server(s) 930. The client(s) 910 are operably connected to one or more client data store(s) 960 that may be employed to store information local to the client(s) 910. Similarly, the server(s) 930 are operably connected to one or more server data store(s) 940 that may be employed to store information local to the servers 930.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Accordingly, the foregoing description and drawings are by way of example only.

The above-described embodiments of the present invention may be implemented in any of numerous ways. For example, the embodiments may be implemented using hardware, software or a combination thereof. When implemented in software, the software code may be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices may be used, among other things, to present a user interface. Examples of output devices that may be used to provide a user interface include printers or display screens for visual presentation of output and speakers or other sound generating devices for audible presentation of output. Examples of input devices that may be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. The computer readable medium or media may be transportable, such that the program or programs stored thereon may be loaded onto one or more different computers or other processors to implement various aspects of the present invention as discussed above.

The terms “program” or “software” are used herein in a generic sense to refer to any type of computer code or set of computer-executable instructions that may be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method of representing data changes in a common format on multiple endpoints, the method comprising:
obtaining, through a first function of a set comprising a plurality of functions that provide information on the changes in the common format, synchronization data on changes to a first copy of data stored in a first underlying schema in a first data store of a first endpoint;
communicating the synchronization data to a second endpoint;
applying the synchronization data to a second function of the set of functions on the second endpoint; and
applying the changes, via the second function, to a second copy of the data stored in a second underlying schema in a second data store of the second endpoint.

2. The method of claim 1, wherein:
data in the first data store and the second data store is represented as a plurality of logical entities representing entities and entity relationships within the data;
a first application executing on the first endpoint utilizes the plurality of logical entities to access the first copy of the data; and
a second application executing on the second endpoint utilizes the plurality of logical entities to access the second copy of the data.

3. The method of claim 2, wherein at least a portion of the plurality functions of the set each receives as an argument a logical entity of the plurality of logical entities.

4. The method of claim 1, wherein the plurality functions comprises at least one of functions for reading the synchronization data and functions for writing the synchronization data.

5. The method of claim 4, wherein the functions for reading the synchronization data comprise entity sets for reading the synchronization data and the functions for writing the synchronization data comprise an ability to update entity sets for writing the synchronization data.

6. The method of claim 1, wherein the plurality functions comprise functions for enumerating the changes, in response to a query including parameters.

7. The method of claim 6, wherein the functions for enumerating the changes can be used to perform a join operation comprising combining information from the data and the synchronization data on the changes in accordance with the parameters.

8. The method of claim 6, wherein the changes comprise at least one of an update, an insertion or a deletion of a record in the copy of the data stored in the first underlying format.

9. The method of claim 6, wherein the parameters comprise at least one of a request to obtain information on a time when the changes were done, a source of the changes and a reason for the changes.

10. The method of claim 1, wherein the synchronization data comprises synchronization metadata on a version of the copy of the data stored in the first underlying format.

11. The method of claim 1, wherein
the plurality of logical entities representing entities and entity relationships within the data comprises an application model,
the plurality of functions comprises a synchronization model, and
the synchronization model is an extension of the application model.

12. The method of claim 1, wherein the synchronization data is available outside of the second endpoint.

13. The method of claim 1, wherein the first endpoint and the second endpoint comprise different change tracking mechanisms.

14. A computer-readable medium having a plurality of computer-executable modules that when executed on at least one processor perform synchronization of copies of data stored on multiple data stores, the computer-executable modules comprising:
an underlying data store module for storing a copy of data in a first underlying format;
an application data model module for mapping a plurality of logical entities to the data in the underlying data store; and
an synchronization data model module providing an interface for:
accessing synchronization metadata on changes to the data in terms of changes to the plurality of logical entities, through a plurality of functions on an endpoint that provide the information on the changes in a common format, and
applying, through the plurality of functions, changes to the data in accordance with changes made to a second copy of the data stored in a second underlying format.

15. A computer-readable medium of claim 14, wherein the application data model represents the data as the plurality of logical entities representing entities and entity relationships within the data.

16. A computer-readable medium of claim 15, wherein the synchronization data model represents the changes to the data though changes to the plurality of logical entities.

17. In a computer system comprising a plurality of endpoints each storing a copy of data and a synchronization component for synchronizing the data between the plurality of endpoints, a method comprising:
obtaining, through a first function of a set comprising a plurality of functions that provide information on the changes in a common format, synchronization data on changes to a first copy of the data stored in a first underlying schema in a first data store of a first endpoint of the plurality of endpoints;
communicating the synchronization data to a second endpoint of the plurality of endpoints;
applying the synchronization data to a second function of the set of functions on the second endpoint; and
applying changes, via the second function, to a second copy of the data stored in a second underlying schema in a second data store of the second endpoint, wherein applying the changes comprises applying changes to the data and synchronization metadata.

18. The method of claim 17, wherein:
data in the first data store and the second data store is represented as a plurality of logical entities representing entities and entity relationships within the data;
a first application executing on the first endpoint utilizes the plurality of logical entities to access the first copy of the data; and
a second application executing on the second endpoint utilizes the plurality of logical entities to access the second copy of the data.

19. The method of claim 18, wherein at least a portion of the plurality functions of the set each receives as an argument a logical entity of the plurality of logical entities.

20. The method of claim 17, wherein the synchronization metadata comprises data on least one of an insertion, deletion or an update to the data, and wherein the method further comprises initiating at least one trigger to record the data on the least one of the insertion, the deletion and the update.
